(19) United States
(12) Patent Application Publication
(10) Pub. No.: US 2026/0243515 A1
(43) Pub. Date: Aug. 20, 2026

(54) DRYING METHOD FOR DRYING DEVICE, DRYING DEVICE, AND COMPUTER READABLE STORAGE MEDIUM

(71) Applicant: WUHU MIDEA SMART KITCHEN APPLIANCE MANUFACTURING CO., LTD., Wuhu (CN)

(72) Inventors: Gangyuan ZHANG, Wuhu (CN); Haiyan LV, Wuhu (CN); Jie GENG, Wuhu (CN); Duo ZHANG, Wuhu (CN)

(21) Appl. No.: 18/841,282

(22) PCT Filed: May 11, 2023
(86) PCT No.: PCT/CN2023/093651

§ 371 Date: Aug. 23, 2024

(30) Foreign Application Priority Data
Apr. 4, 2023 (CN) 202310373299.4
Apr. 4, 2023 (CN) 202310373389.3

(51) Int. Cl. F26B 25/22

(52) U.S. Cl. CPC F26B 25/22

(57) ABSTRACT

A drying method includes obtaining a drying parameter of a drying device, determining a target drying action of the drying device based on a drying procedure matching the drying parameter, and controlling the drying device to execute the target drying action.

### RELATED APPLICATION

This application claims priority to Chinese patent application Nos. 202310373299.4 and 202310373389.3 filed on Apr. 4, 2023, the entire contents of which are incorporated herein by reference.

### FIELD

The present disclosure relates to the field of drying, and more particularly, to a drying method for a drying device, a drying device, and a readable storage medium.

### BACKGROUND

Dishwashers with a drying function have high demand in market. Climatic and geographical factors make use scenarios of the drying function complex, resulting in higher requirements on the drying logic of the drying function.

In the related art, mainstream drying modes include natural condensation, cold air drying, etc. These drying manners can achieve a satisfactory drying effect under certain specific conditions. However, all drying actions become ineffective after a period of execution. To further increase dryness, it is needed to switch a current drying action to a next drying action, but there is no guarantee that the next drying action can improve the drying effect, resulting in a low drying efficiency.

The above content is intended to assist in understanding of technical solutions of the present disclosure only, and does not represent an admission that the above content is the related art.

### SUMMARY

A main objective of the present disclosure is to provide a drying method for a drying device, a drying device, and a readable storage medium, aiming to improve a drying efficiency of the drying device.

To achieve the above objective, the present disclosure provides a drying method. The drying method includes: obtaining a drying parameter of the drying device; determining a target drying action of the drying device based on a drying procedure matching the drying parameter; and controlling the drying device to execute the target drying action.

In an embodiment, the determining the target drying action of the drying device based on the drying procedure matching the drying parameter includes: determining at least one candidate drying action based on the drying procedure; determining dryness change data corresponding to the at least one candidate drying action in the drying procedure; and determining the target drying action from the at least one candidate drying action based on the dryness change data.

In an embodiment, the determining the target drying action from the at least one candidate drying action based on the dryness change data includes: obtaining current dryness of the drying device; determining, based on the current dryness and the dryness change data, a drying duration and a dryness change value that correspond to the at least one candidate drying action; and determining the target drying action based on the drying duration and the dryness change value.

In an embodiment, the dryness change data includes a plurality of time values and dryness corresponding to each of the plurality of time values. The determining, based on the current dryness and the dryness change data, the drying duration and the dryness change value that correspond to the at least one candidate drying action includes: determining a time point corresponding to the current dryness based on the current dryness and the dryness change data; and determining the drying duration and the dryness change value based on the time point, the current dryness, and the dryness change data.

In an embodiment, the determining the target drying action based on the drying duration and the dryness change value includes: obtaining a minimum cumulative duration required for a trend prediction of the at least one candidate drying action; and determining a drying rate corresponding to the at least one candidate drying action based on the drying duration and the dryness change value, and determining a candidate drying action, of the at least one candidate drying action, having the drying duration longer than the minimum cumulative duration and having a greatest drying rate as the target drying action.

In an embodiment, the determining the at least one candidate drying action based on the drying procedure includes: determining an executed drying action, which is already executed by the drying device, based on the drying parameter; determining a next drying action, in the drying procedure, corresponding to the executed drying action based on an execution sequence of the drying procedure; and determining the next drying action as the candidate drying action.

In an embodiment, the drying parameter includes a record of executed drying actions which are already executed during a current drying process of the drying device and a humidity parameter corresponding to the drying device. The humidity parameter includes ambient humidity of an environment where the drying device is located and/or maximum humidity corresponding to a drying region of the drying device.

In an embodiment, the drying method further includes, prior to the determining the target drying action of the drying device based on the drying procedure matching the drying parameter: pre-storing a plurality of drying procedures; or collecting a plurality of pieces of execution data of the drying device, generating and updating the drying procedure, or updating a pre-stored drying procedure, based on the plurality of pieces of execution data of the drying device.

In an embodiment, the drying method further includes, subsequent to the controlling the drying device to execute the target drying action: determining dryness of the drying device at intervals of a predetermined cycle in response to initiating the target drying action; predicting a drying trend of the target drying action based on the dryness corresponding to a plurality of predetermined cycles; and re-executing the obtaining the drying parameter of the drying device, in response to determining based on a prediction result that the target drying action fails in a future time period.

In addition, to achieve the above objective, the present disclosure further provides a drying device. The drying device includes a memory, a processor, and a drying program stored on the memory and executable on the processor. The drying program is configured to implement, when executed by the processor, the steps of the drying method as described above.

The present disclosure further provides a drying method for a drying device. The drying method includes: obtaining drying progress parameters of a drying region at intervals of a first predetermined cycle; predicting a drying trend of a current drying action based on the drying progress parameters to obtain a prediction result; and determining an execution state of the current drying action based on the prediction result.

In an embodiment, the predicting the drying trend of the current drying action based on the drying progress parameters to obtain the prediction result includes: predicting, in response to a quantity of the obtained drying progress parameters reaching a predetermined value, the drying trend of the current drying action based on the drying progress parameters.

In an embodiment, the drying progress parameters include dryness. The obtaining the drying progress parameters of the drying region at intervals of the first predetermined cycle includes: obtaining maximum humidity corresponding to the drying region; determining real-time humidity of the drying region at intervals of the first predetermined cycle; and determining the dryness based on the real-time humidity and the maximum humidity.

In an embodiment, the determining the dryness based on the real-time humidity and the maximum humidity includes: obtaining ambient humidity of an environment where the drying device is located; and determining the dryness based on the real-time humidity, the ambient humidity corresponding to the drying device, and the maximum humidity.

In some embodiments, the method further includes: obtaining, in response to initiating the current drying action, pre-stored maximum humidity associated with the drying region; obtaining, in response to failing to obtain the pre-stored maximum humidity, the maximum humidity corresponding to the drying region; and recording, in response to successfully obtaining the pre-stored maximum humidity, the real-time humidity of the drying region at intervals of the first predetermined cycle based on the pre-stored maximum humidity.

In an embodiment, the maximum humidity includes maximum absolute humidity. The obtaining the maximum humidity corresponding to the drying region includes: detecting temperature data and humidity data of the drying region at intervals of a second predetermined cycle; determining absolute humidity of the drying region corresponding to the second predetermined cycle based on the temperature data and the humidity data; and determining the maximum absolute humidity based on the absolute humidity corresponding to a plurality of second predetermined cycles.

In an embodiment, the drying progress parameters include real-time absolute humidity. The determining and recording the drying progress parameters of the drying region at intervals of the first predetermined cycle includes: detecting a real-time temperature and real-time humidity of the drying region at intervals of the first predetermined cycle; and determining and recording the real-time absolute humidity of the drying region based on the real-time temperature and the real-time humidity.

In an embodiment, the predicting the drying trend of the current drying action based on the drying progress parameters to obtain the prediction result includes: determining a predictive drying progress parameter corresponding to a future predetermined time period based on the drying progress parameters; determining a rate of change of the predictive drying progress parameter corresponding to the future predetermined time period; and predicting the drying trend based on the rate of change corresponding to the future predetermined time period to obtain the prediction result.

In an embodiment, the predicting the drying trend based on the rate of change corresponding to the future predetermined time period to obtain the prediction result includes: determining that the current drying action is effective in the future when the rate of change is greater than a predetermined value; and determining that the current drying action is to fail in the future when the rate of change is smaller than or equal to the predetermined value.

In an embodiment, the determining the execution state of the current drying action based on the prediction result includes: determining, when the current drying action is effective in the future, the execution state as maintaining the current drying action; and determining, when the current drying action is to fail in the future, the execution state as executing a next drying action.

In addition, to achieve the above objective, the present disclosure further provides a computer-readable storage medium. The computer-readable storage medium stores a drying program. The drying program is configured to implement, when executed by a processor, the steps of the drying method as described above.

With the method, the drying parameter of the drying device is obtained. The target drying action of the drying device is determined based on the drying procedure matching the drying parameter. The drying device is controlled to execute the target drying action. In this way, based on the drying parameter, a suitable target drying action to be executed by the drying device in a current state can be found among the drying actions in a plurality of drying procedures, providing a satisfactory drying effect. Therefore, the drying efficiency can be improved.

### BRIEF DESCRIPTION OF THE DRAWINGS

FIG. 1 is a schematic diagram of a structure of a terminal of a hardware operation environment according to an embodiment of the present disclosure.

FIG. 2 is a flowchart of an embodiment of a drying method of the present disclosure.

FIG. 3 is a flowchart of another embodiment of a drying method of the present disclosure.

FIG. 4 is a flowchart of yet another embodiment of a drying method of the present disclosure.

FIG. 5 is a flowchart of an embodiment of a drying method of the present disclosure.

FIG. 6 is a flowchart of still yet another embodiment of a drying method of the present disclosure.

Implementations of the objects, functional features, and advantages of the present disclosure will be further described in connection with the embodiments and with reference to the accompanying drawings.

### DETAILED DESCRIPTION OF THE EMBODIMENTS

It should be understood that specific embodiments described herein are intended to explain the present disclosure only, rather than to limit the present disclosure.

Different drying effects are produced by different combinations of drying actions. Therefore, when there is a need to switch a current drying action, executing a next drying action based on a predetermined sequence may produce an unsatisfactory drying effect, resulting in a low drying efficiency of the drying device.

To improve the drying efficiency of the drying device, a drying method for a drying device, a drying device, and a readable storage medium are provided according to embodiments of the present disclosure. The method includes: obtaining a drying parameter of the drying device; determining a target drying action of the drying device based on a drying procedure matching the drying parameter; and controlling the drying device to execute the target drying action.

In this way, based on the drying parameter, a suitable target drying action to be executed by the drying device in a current state can be found among the drying actions in a plurality of drying procedures, providing a satisfactory drying effect. Therefore, the drying efficiency can be improved.

The contents claimed by the appended claims of the present disclosure are described in detail below in conjunction with the accompanying drawings.

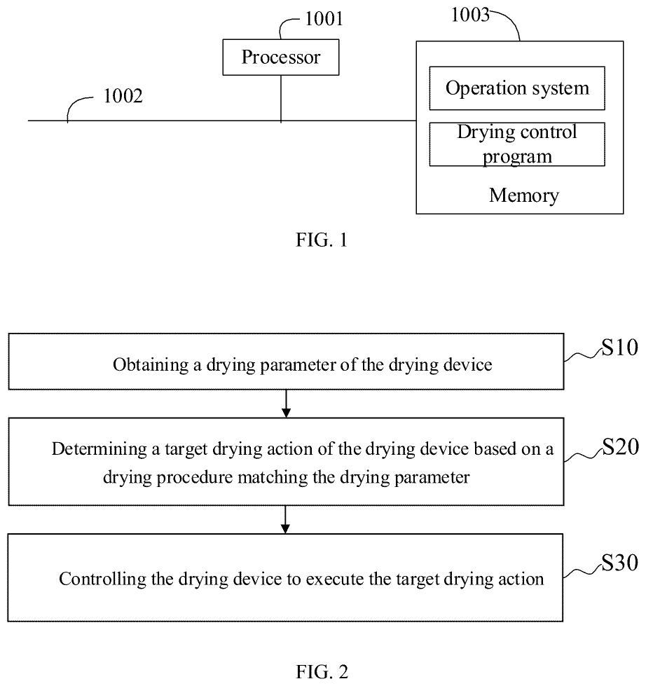

FIG. 1 is a schematic diagram of a structure of a terminal of a hardware operation environment according to an embodiment of the present disclosure.

A terminal according to the embodiments of the present disclosure may be a drying device.

As illustrated in FIG. 1, the terminal may include a processor 1001 such as a Central Processing Unit (CPU), a memory 1003, and a communication bus 1002. The communication bus 1002 is configured to implement a connection and communication between these components. The memory 1003 may be a high-speed Random Access Memory (RAM) or a non-volatile memory, such as a magnetic disk storage. In another exemplary embodiment of the present disclosure, the memory 1003 may be a storage device independent of the processor 1001 described above.

Those skilled in the art can understand that the terminal structure illustrated in FIG. 1 does not constitute a limitation of the terminal. The terminal may include more or fewer components than those illustrated in the figures, or combine certain components, or have a different arrangement of components.

As illustrated in FIG. 1 the memory 1003 as a computer storage medium may include an operation system and a drying program.

In the terminal illustrated in FIG. 1, the processor 1001 may be configured to invoke the drying program stored in the memory 1003 to perform the following operations of: obtaining a drying parameter of the drying device; determining a target drying action of the drying device based on a drying procedure matching the drying parameter; and controlling the drying device to execute the target drying action.

In an embodiment, the processor 1001 may be configured to invoke the drying program stored in the memory 1003 and perform the following operations of: determining at least one candidate drying action based on the drying procedure; determining dryness change data corresponding to the at least one candidate drying action in the drying procedure; and determining the target drying action from the at least one candidate drying action based on the dryness change data.

In an embodiment, the processor 1001 may be configured to invoke the drying program stored in the memory 1003 and perform the following operations of: obtaining current dryness of the drying device; determining, based on the current dryness and the dryness change data, a drying duration and a dryness change value that correspond to the at least one candidate drying action; and determining the target drying action based on the drying duration and the dryness change value.

In an embodiment, the processor 1001 may be configured to invoke the drying program stored in the memory 1003 and perform the following operations of: determining a time point corresponding to the current dryness based on the current dryness and the dryness change data; and determining the drying duration and the dryness change value based on the time point, the current dryness, and the dryness change data.

In an embodiment, the processor 1001 may be configured to invoke the drying program stored in the memory 1003 and perform the following operations of: obtaining a minimum cumulative duration required for a trend prediction of the at least one candidate drying action; and determining a drying rate corresponding to the at least one candidate drying action based on the drying duration and the dryness change value, and determining a candidate drying action, of the at least one candidate drying action, having the drying duration longer than the minimum cumulative duration and having a greatest drying rate as the target drying action.

In an embodiment, the processor 1001 may be configured to invoke the drying program stored in the memory 1003 and perform the following operations of: determining an executed drying action, which is already executed by the drying device, based on the drying parameter; determining a next drying action, in the drying procedure, corresponding to the executed drying action based on an execution sequence of the drying procedure; and determining the next drying action as the candidate drying action.

In an embodiment, the processor 1001 may be configured to invoke the drying program stored in the memory 1003 and perform the following operations of: pre-storing a plurality of drying procedures; or collecting a plurality of pieces of execution data of the drying device, generating and updating the drying procedure, or updating a pre-stored drying procedure, based on the plurality of pieces of execution data of the drying device.

In an embodiment, the processor 1001 may be configured to invoke the drying program stored in the memory 1003 and perform the following operations of: obtaining, in response to initiating the target drying action, pre-stored maximum humidity associated with the drying region of the drying device; determining real-time humidity of the drying region at intervals of a predetermined cycle; and determining the dryness corresponding to the predetermined cycle based on the real-time humidity, the ambient humidity corresponding to the drying device, and the pre-stored maximum humidity; predicting a drying trend of the target drying action based on the dryness corresponding to a plurality of predetermined cycles; and re-executing the operation of obtaining the drying parameter of the drying device, in response to determining that the target drying action fails in a future time period.

In the terminal illustrated in FIG. 1, the processor 1001 may be further configured to invoke the drying program stored in the memory 1003 and perform the following operations of: obtaining drying progress parameters of a drying region at intervals of a first predetermined cycle; predicting a drying trend of a current drying action based on the drying progress parameters to obtain a prediction result; and determining an execution state of the current drying action based on the prediction result.

In an embodiment, the processor 1001 may be configured to invoke the drying program stored in the memory 1003 and perform the following operations of: predicting, in response to a quantity of the obtained drying progress parameters reaching a predetermined value, the drying trend of the current drying action based on the drying progress parameters.

In an embodiment, the processor 1001 may be configured to invoke the drying program stored in the memory 1003 and perform the following operations of: obtaining maximum humidity corresponding to the drying region; determining real-time humidity of the drying region at intervals of the first predetermined cycle; and determining the dryness based on the real-time humidity and the maximum humidity.

In an embodiment, the processor 1001 may be configured to invoke the drying program stored in the memory 1003 and perform the following operations of: obtaining ambient humidity of an environment where the drying device is located; and determining the dryness based on the real-time humidity, the ambient humidity corresponding to the drying device, and the maximum humidity.

In an embodiment, the processor 1001 may be configured to invoke the drying program stored in the memory 1003 and perform the following operations of: obtaining, in response to initiating the current drying action, pre-stored maximum humidity associated with the drying region; obtaining, in response to failing to obtain the pre-stored maximum humidity, the maximum humidity corresponding to the drying region; and recording, in response to successfully obtaining the pre-stored maximum humidity, the real-time humidity of the drying region at intervals of the first predetermined cycle based on the pre-stored maximum humidity.

In an embodiment, the processor 1001 may be configured to invoke the drying program stored in the memory 1003 and perform the following operations of: detecting temperature data and humidity data of the drying region at intervals of a second predetermined cycle; determining absolute humidity of the drying region corresponding to the second predetermined cycle based on the temperature data and the humidity data; and determining the maximum absolute humidity based on the absolute humidity corresponding to a plurality of second predetermined cycles.

In an embodiment, the processor 1001 may be configured to invoke the drying program stored in the memory 1003 and perform the following operations of: detecting a real-time temperature and real-time humidity of the drying region at intervals of the first predetermined cycle; and determining and recording the real-time absolute humidity of the drying region based on the real-time temperature and the real-time humidity.

In an embodiment, the processor 1001 may be configured to invoke the drying program stored in the memory 1003 and perform the following operations of: determining a predictive drying progress parameter corresponding to a future predetermined time period based on the drying progress parameters; determining a rate of change of the predictive drying progress parameter corresponding to the future predetermined time period; and predicting the drying trend based on the rate of change corresponding to the future predetermined time period to obtain the prediction result.

In an embodiment, the processor 1001 may be configured to invoke the drying program stored in the memory 1003 and perform the following operations of: determining that the current drying action is effective in the future when the rate of change is greater than a predetermined value; and determining that the current drying action is to fail in the future when the rate of change is smaller than or equal to the predetermined value.

In an embodiment, the processor 1001 may be configured to invoke the drying program stored in the memory 1003 and perform the following operations of: determining, when the current drying action is effective in the future, the execution state as maintaining the current drying action; and determining, when the current drying action is to fail in the future, the execution state as executing a next drying action.

The contents claimed by the appended claims of the present disclosure will be explained below by means of specific exemplary solutions, in such a manner that those skilled in the art can better understand the protection scope of the appended claims of the present disclosure. It should be understood that the following exemplary solutions are only used to explain the present disclosure, rather than limiting the protection scope of the present disclosure.

Exemplarily, as illustrated in FIG. 2, according to an embodiment of the drying method of the present disclosure, the drying method includes operations at blocks S10 to S30.

At block S10, a drying parameter of the drying device is obtained.

In the present disclosure, a drying process is executed by the drying device. In one drying process, a plurality of drying actions need to be executed by the drying device. A sequence in which the drying device executes the plurality of drying actions is not determined when the drying device enters the drying process. A next drying action to be executed needs to be recommended based on a current drying parameter. The drying parameter characterizes an operation environment and an operation state of the drying device in a current state.

At block S20, a target drying action of the drying device is determined based on a drying procedure matching the drying parameter.

In the present disclosure, subsequent to obtaining of the drying parameter of the drying device, a plurality of drying procedures that can agree with the drying parameter are matched. The drying procedure includes a plurality of drying actions having an execution sequence and execution data corresponding to the drying procedure. An execution situation corresponding to each drying action in the drying procedure may be determined based on the execution data of the drying procedure. Since the drying procedures all match the drying parameter, the operation environment and the operation state of the drying procedure are consistent with a current drying process. According to the execution data of each drying procedure, a drying action that can produce a relatively satisfactory drying effect under the operation environment and the operation state that correspond to the above-mentioned drying parameter can be selected from the drying procedures and determined as the target drying action.

At block S30, the drying device is controlled to execute the target drying action.

In the present disclosure, subsequent to an identification of a corresponding target drying action from a plurality of drying procedures matching the drying parameter, the target drying action can also provide the satisfactory drying effect for the drying device based on the same or similar drying parameter, considering that the target drying action can also achieve the satisfactory drying effect in the drying procedure matching the drying parameter. The drying device can be controlled to execute the target drying action to achieve a relatively satisfactory drying effect.

In the technical solutions disclosed in the present disclosure, a plurality of drying procedures are matched based on the drying parameter of the drying device. The target drying action suitable for the drying device in a current state can be found from the plurality of matched drying procedures. Therefore, a more satisfactory drying effect can be provided, improving a drying efficiency.

In an embodiment, the drying parameter includes a record of executed drying actions which are already executed during a current drying process of the drying device and a humidity parameter corresponding to the drying device. The humidity parameter includes ambient humidity of an environment where the drying device is located and/or maximum humidity corresponding to a drying region of the drying device.

When a plurality of drying actions are executed by the drying device, a correlation exists between the drying actions. The operation states generated by the previously executed drying actions affect an effect of the later executed drying action. Therefore, the drying parameter includes the record of executed drying actions which are already executed during the current drying process of the drying device. For example, the currently executed drying action is: action a-action b-action c. In addition, during drying, the drying action can also produce different drying effects in different operation environments corresponding to a same drying device. The humidity parameter in the operation environment has the greatest influence on an effect of the drying action. Therefore, the drying parameter further includes the humidity parameter corresponding to the drying device. In an exemplary embodiment of the present disclosure, the drying parameter may specifically include an ambient humidity of an environment where the drying device is located and/or maximum humidity corresponding to a drying region of the drying device. The maximum humidity may be the maximum humidity that the drying device can reach in the drying region subsequent to entrance of the drying process. The maximum humidity may be characterized by maximum absolute humidity or maximum relative humidity of the drying region. The ambient humidity may be characterized by absolute ambient humidity or relative ambient humidity of the environment where the drying device is located.

In the drying process or the drying procedure, a humidity detection device has a measurement limit, and residual water keeps evaporating due to a water temperature and the drying action. Therefore, at the beginning of the drying process or the drying procedure or within a short period of time after the beginning of the drying process or the drying procedure, the humidity of the drying region quickly reaches a maximum limit, and maintains at the maximum limit of humidity for a long time. With the operation of the drying action, the humidity of the drying region gradually decreases with the operation of the drying process or the drying procedure.

The drying procedure in which the humidity data is consistent with the humidity data of the current drying process may be determined from a plurality of stored drying procedures based on the humidity data determined as a first target classification condition. The record of executed drying actions may be determined as a second target classification condition, in such a manner that the drying procedure having drying actions executed in a same sequence as the record of executed drying actions is determined from the plurality of stored drying procedures. For example, the record of executed drying actions is: action a-action b-action c. Therefore, the drying procedure (action a-action b-action c-action d-action e-action f) and the drying procedure (action a action b-action c-action g-action e) satisfy the second target classification condition, while the drying procedure (action a-action b-action e-action c) does not satisfy the second target classification condition. The drying procedure satisfying the first target classification condition and the second target classification condition may be determined as the drying procedure matching the drying parameter. To save time, at least one drying procedure satisfying the first target classification condition may be determined, and then the drying procedure satisfying the second target classification condition may be determined from the at least one drying procedure satisfying the first target classification condition. In some embodiments, the at least one drying procedure satisfying the second target classification condition may be determined, and then the at least one drying procedure satisfying the first target classification condition may be determined from the at least one drying procedure satisfying the second target classification condition.

In some embodiments, the method further includes, prior to the operation at block S20: pre-storing a plurality of drying procedures; or collecting a plurality of pieces of execution data of the drying device, generating and updating the drying procedure, or updating a pre-stored drying procedure, based on the plurality of pieces of execution data of the drying device.

Since it is needed to match a plurality of drying procedures, a plurality of drying procedures need to be stored prior to performing the operation at block S20. A plurality of drying procedures may be obtained directly and pre-stored by the drying device. In an exemplary embodiment of the present disclosure, a plurality of drying procedures may be pre-stored before the drying device leaves the factory, or the drying device may be connected to a server for the server to transmit drying procedures to the drying device. The drying procedures transmitted by the server may be generated and updated by other drying devices, and transmitted to the server by the other drying devices.

The drying device may also be configured to collect a plurality of pieces of execution data of the drying device. The execution data may include the absolute ambient humidity, the maximum absolute humidity, an execution sequence of drying actions, dryness corresponding to an execution of the drying actions, dryness at the end of final drying, and the like. The drying procedure is generated and updated based on the execution data. In an exemplary embodiment of the present disclosure, the execution sequence of the drying actions is determined, and then the drying procedure is generated based on the execution sequence of drying actions and the execution data. Then, based on the execution sequence of the drying actions and dryness change data, and in response to receiving execution data having a same execution sequence of drying actions as the stored drying procedure, the drying procedure may be updated based on the execution data. The dryness change data of the entire drying procedure or the dryness change data of each drying operation corresponding to the drying procedure may be determined based on the execution data.

In this way, the plurality of drying procedures may be pre-stored; or the plurality of pieces of execution data of the drying device are collected, the drying procedure is generated and updated, or the pre-stored drying procedure is updated, based on the plurality of pieces of execution data of the drying device. In this way, during matching of the drying procedure, many choices are available, which simplifies an identification of a drying procedure having a higher matching degree. Therefore, an accuracy in determining the target drying action is improved, improving the drying efficiency.

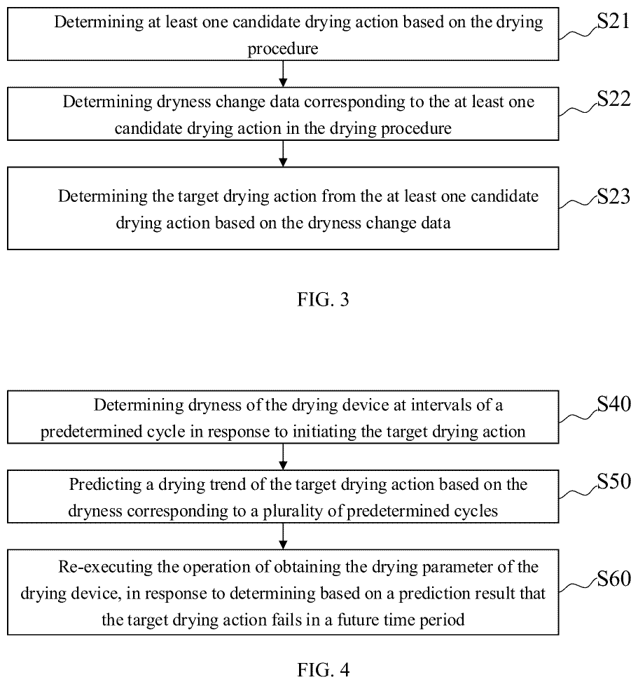

In an embodiment, as illustrated in FIG. 3, based on any of the above embodiments, in another embodiment of the drying method of the present disclosure, the operation at block S20 includes operations at blocks S21 to S23.

At block S21, at least one candidate drying action is determined based on the drying procedure.

In the present disclosure, the drying procedure includes a plurality of drying actions having an execution sequence. One or more drying actions may be selected from the drying procedure based on the drying parameter as the at least one candidate drying action.

At block S22, dryness change data corresponding to the at least one candidate drying action in the drying procedure is determined.

In the present disclosure, the dryness change data of the entire drying procedure or the dryness change data of each drying operation corresponding to the drying procedure may be determined based on the execution data in the drying procedure. Further, the dryness change data corresponding to the at least one candidate drying action in the corresponding drying procedure is determined based on the execution data. The dryness change data may characterize a dryness change of the drying device between a start of an execution of the at least one candidate drying action and an end of the execution of the at least one candidate drying action in the corresponding drying procedure.

When the dryness change data of the entire drying procedure can be determined based on the execution data of the drying procedure, the dryness change data of the entire drying procedure is separated based on the execution sequence of the drying actions in the drying procedure, to determine the dryness change data corresponding to the at least one candidate drying action.

At block S23, the target drying action is determined from the at least one candidate drying action based on the dryness change data.

In the present disclosure, a drying effect of the at least one candidate drying action in the corresponding drying procedure can be determined based on the dryness change data. Since the drying procedure matches the drying parameter, the drying effect achieved by the at least one candidate drying action in the corresponding drying procedure also achieves a same effect in the current drying process. Therefore, the drying action providing a relatively satisfactory drying effect can be selected as the target drying action from the at least one candidate drying action based on a drying change parameter.

In an embodiment, current dryness of the drying device is obtained. A drying duration and a dryness change value that correspond to the at least one candidate drying action are determined based on the current dryness and the dryness change data. The target drying action is determined based on the drying duration and the dryness change value.

The current dryness of the drying device is obtained. The dryness change value, which occurs under an action of the at least one candidate drying action when the current dryness is reached in the drying procedure, and the drying duration corresponding to the dryness change value are determined based on the current dryness and the dryness change data. Then, the drying action that is more in line with a drying requirement is selected as the target drying action from the at least one candidate drying action based on the dryness change value and the drying duration corresponding to the dryness change value, to achieve a more satisfactory drying effect, improving the drying efficiency.

When the drying action in the drying procedure is switched in response to a dryness failure, the target drying action may be determined from the at least one candidate drying action based on the dryness change value and/or the drying duration. Otherwise, a drying rate may be calculated based on the dryness change value and the drying duration, and the target drying action may be determined from the at least one candidate drying action based on the drying rate.

In an embodiment, the dryness change data includes a plurality of time values and dryness corresponding to each of the plurality of time values. The operation of determining, based on the current dryness and the dryness change data, the drying duration and the dryness change value that correspond to the at least one candidate drying action includes: determining a time point corresponding to the current dryness based on the current dryness and the dryness change data; and determining the drying duration and the dryness change value based on the time point, the current dryness, and the dryness change data.

The dryness change data includes the plurality of time values and the dryness corresponding to each of the plurality of time values, i.e., a correspondence between dryness and time. A time range corresponding to when the at least one candidate drying action produces a drying impact in the drying procedure and a dryness range corresponding to the drying impact may be determined based on the dryness change data. Then, a relationship between the current dryness and the dryness is determined. When the current dryness is smaller than a minimum value of the dryness range, the dryness range is determined as the dryness change value, and the time range is determined as the drying duration. When the dryness falls within the dryness range, a test function corresponding to the at least one candidate drying action may be determined based on the plurality of time values and the dryness corresponding to each of the plurality of time values. A time point corresponding to the current dryness may be determined based on the test function. A difference between the time point and an end time point of the time range is determined as the drying duration. A difference between the current dryness and a maximum value of the dryness range is determined as the dryness range. The drying rate is calculated based on the dryness change value and the drying duration. The target drying action is determined from the at least one candidate drying action based on the drying rate.

In an embodiment, a minimum cumulative duration required for a trend prediction of the at least one candidate drying action is obtained. A drying rate corresponding to the at least one candidate drying action is determined based on the drying duration and the dryness change value. A candidate drying action, of the at least one candidate drying action, having the drying duration longer than the minimum cumulative duration and having a greatest drying rate is determined as the target drying action.

When the current drying process is performed, a trend prediction may be performed on the currently executed drying action to determine the drying effect of the currently executed drying action. In this way, when the current drying action fails, the current drying action may be switched to a next drying action in time to improve the drying effect. To perform the trend prediction, the current drying action needs to run for a sufficient time period. The trend prediction also needs to be performed on the target drying action subsequent to a determination of the target drying action. Therefore, the minimum cumulative duration required for the trend prediction is introduced in response to performing a selection on the at least one candidate drying action.

The minimum cumulative duration required for the trend prediction of the at least one candidate drying action is obtained. When the drying duration is longer than the minimum cumulative duration, the at least one candidate drying action is not determined as the target drying action. Therefore, a final condition for selecting the target drying action is that the candidate drying action of the at least one candidate drying action has the greatest drying rate, which can produce an optimal drying effect to improve the drying efficiency of the entire drying process. In addition, the drying duration of the candidate drying action needs to be longer than the minimum cumulative duration required for the trend prediction. During an execution of the candidate drying action, the trend prediction can be performed on the candidate drying action, to switch to the next drying action in time in response to that the candidate drying action fails.

In the technical solutions disclosed in the present disclosure, the at least one candidate drying action is determined based on the execution sequence of the drying procedure. The dryness change data corresponding to the at least one candidate drying action in the drying procedure is determined. The target drying action is determined from the at least one candidate drying action based on the dryness change data. The target drying action having a more satisfactory drying effect can be selected based on the dryness change data that characterizes the drying effect, and thus the drying efficiency of the drying device can be improved.

In an embodiment, the operation at block S21 includes: determining an executed drying action, which is already executed by the drying device, based on the drying parameter; determining a next drying action, in the drying procedure, corresponding to the executed drying action based on an execution sequence of the drying procedure; and determining the next drying action as the candidate drying action.

When the drying parameter includes the record of executed drying actions, the record of executed drying actions may include a record of all drying actions or a predetermined number of recently-executed consecutive drying actions in the current drying process. In this way, an arrangement sequence of the all drying actions or the predetermined number of recently-executed consecutive drying actions may be determined based on the record of executed drying actions. The drying procedure which is more instructive for the next target operation of the drying device may be matched based on the arrangement sequence and/or the humidity parameter. That is, the execution sequence of the drying actions in the drying procedure includes the above arrangement sequence, and/or the humidity parameter corresponding to the drying procedure is the same as the humidity parameter corresponding to the current drying process or a difference between the humidity parameter corresponding to the drying procedure and the humidity parameter corresponding to the current drying process falls within a predetermined range. In this way, an improvement of a determination of adaptability between the target drying action and the drying device can be facilitated, which further improves the drying efficiency.

Therefore, the execution sequence of individual drying actions in each drying procedure can be determined. The at least one candidate drying action may be determined from the drying procedure based on the execution sequence and a record of drying actions having consistent drying parameters. In an exemplary embodiment of the present disclosure, during matching of the drying procedure, an arrangement sequence of all or part of the executed drying actions of the current drying process may be determined based on the record of executed drying actions which are already executed, e.g., action a-action b-action c. The drying procedure, of the stored drying procedures, having the arrangement sequence in the execution sequence is determined as the matched drying procedure. A next drying action, in each drying procedure, corresponding to the arrangement sequence is determined based on the execution sequence in each matched drying procedure, and is determined as the candidate drying action. In this way, at least one candidate drying action can be found for each matched drying procedure.

In an embodiment, when only one matched drying procedure is available, the next drying action following the sequence combination in the drying procedure may be directly determined as the target drying action.

Since a correlation between drying actions affects the drying effect, the dryness change data of the at least one candidate drying action determined in this way in the corresponding drying procedure is more in line with the dryness change data generated by the current drying process when the at least one candidate drying action is executed. Therefore, the target drying operation can be accurately determined based on the dryness change data of the at least one candidate drying action to improve the drying efficiency.

In an embodiment, as illustrated in FIG. 4, based on any of the above embodiments, in yet another embodiment of the drying method of the present disclosure, the method further includes operations at blocks S40 to S60 subsequent to the operation at block S30.

At block S40, dryness of the drying device is determined at intervals of a predetermined cycle in response to initiating the target drying action.

At block S50, a drying trend of the target drying action is predicted based on the dryness corresponding to a plurality of predetermined cycles.

At block S60, obtaining the drying parameter of the drying device is re-executed, in response to determining based on a prediction result that the target drying action fails in a future time period.

In the present disclosure, the target drying action is the current drying action of the drying device in response to initiating the target drying action. The trend prediction may be performed on the target drying action determined as the current drying action. Pre-stored maximum humidity associated with the drying region of the drying device may be obtained in response to initiating the target drying action. The pre-stored maximum humidity may be absolute humidity determined, in response to initiating the current drying process, through temperature data and humidity data that are detected for a plurality of drying regions. The real-time humidity of the drying region is determined at intervals of a predetermined cycle subsequent to an initiation of the target drying action. The dryness corresponding to each predetermined cycle is determined based on actual real-time humidity, the ambient humidity corresponding to the drying device, and the pre-stored maximum humidity. Humidity data such as the maximum humidity and the real-time humidity may be the absolute humidity. Therefore, a drying trend of the target drying action is predicted based on the dryness corresponding to each predetermined cycle. Based on determination that the target drying action is to fail in a future period based on the drying trend, a need for the drying device to switch the drying action is determined to exist, and thus a new target drying action needs to be determined. Therefore, the operation at block S10 is re-executed, until a target drying result of the drying process is satisfied.

For a better understanding, a specific application scenario is provided.

Execution data in the past drying activities of the drying device is collected, including the absolute ambient humidity, the maximum absolute humidity, the execution sequence of the drying actions, the dryness corresponding to the execution of each drying action, and dryness at an end of the drying procedure. Overall dryness change data of the drying procedure is fitted based on the execution data. The overall dryness change data may be the dryness change data corresponding to each drying action in the drying procedure. The dryness change data may be represented by a function fᵢ. The function fᵢ represents the correspondence between time and dryness.

When the drying device starts to execute the drying process, the trend prediction is performed on drying action A currently executed by the drying process. When the maximum absolute humidity corresponding to the drying region of the drying device is not obtained prior to an execution of the drying action A, the maximum absolute humidity is re-obtained during the execution of the drying action A. Temperature data and humidity data provided by a temperature and humidity detection device are obtained once at an interval of t_{A} subsequent to an end of a sustained period of the maximum absolute humidity. The real-time absolute humidity is calculated. Real-time dryness is calculated based on the maximum absolute humidity, the real-time absolute humidity, and the absolute ambient humidity and saved. When dryness in a quantity of at least n_{A} is determined cumulatively, the trend prediction is performed. When a cumulative quantity of the dryness exceeds n_{A}, the trend prediction is performed using all accumulated dryness. For the drying action A, a change trend of dryness in a quantity of m_{A} in the future may be determined, and a corresponding change rate P is determined. Threshold P_{A} is compared with the change rate P. When p≥P_{A}, the trend of the dryness in the future is considered as being stable, which means that the current drying action A fails in the future time period. When p<P_{A}, the trend of the dryness in the future is considering as declining, which means that the current drying action A is still effective in the future time period. When a determination result indicates that the current drying action A fails, a determination state of a next target drying action is entered.

Part of the drying procedures (a-b-c-d), (b-v-c-b), (a-b-d-f), and (s-a-b-s-g) are matched from the plurality of drying procedures based on the absolute ambient humidity and the maximum absolute humidity that are obtained previously. Part of the drying procedures (a-b-c-d), (a-b-d-f), and (s-a-b-s-g) are matched from the above-mentioned part of the drying procedures based on a sequence combination (a-b) of the executed drying actions of the current drying process. The dryness change data fᵢ corresponding to the candidate drying action numbered i (i=c, d, s) and possibly to be executed is determined from the above drying procedure. Correspondingly, the drying duration Δtᵢ and the dryness change value ΔDᵢ that correspond to the candidate drying action i when executing the candidate drying action i are determined. The drying rate

$${k}_{i} = \frac{Δ {D}_{i}}{Δ {t}_{i}}$$

is calculated. The candidate drying action having the minimum drying rate kᵢ and having the drying duration longer than or equal to the minimum cumulative duration is determined as the target drying action. The drying device is controlled to execute the target drying action.

In the technical solutions disclosed in the present disclosure, the trend prediction is performed on the currently executed drying action of the drying process to determine whether to perform the next drying action. The next drying action is determined to be performed in response to the drying action failing in the future time period. In addition, the target drying action is determined through the drying procedure matching the drying parameter of the drying device. Therefore, the drying effect of the drying device can be improved.

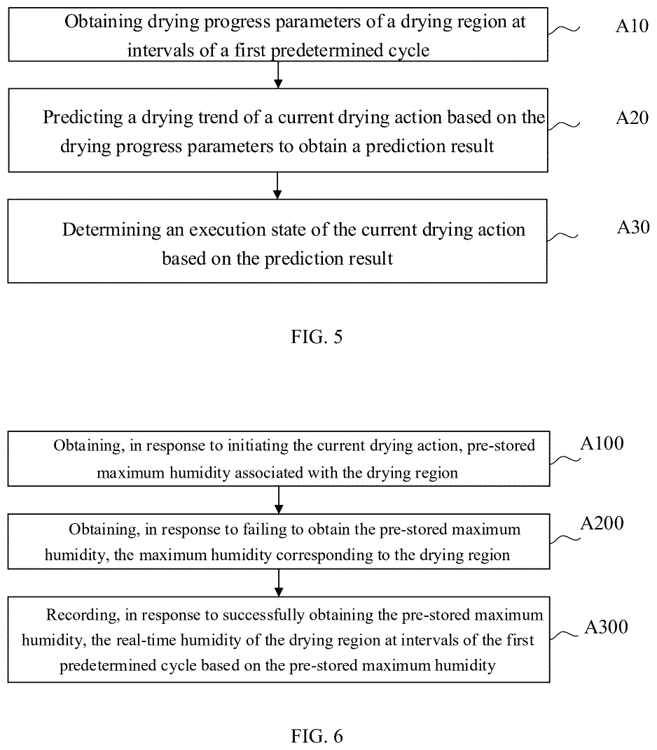

In an exemplary embodiment, as illustrated in FIG. 5, according to an embodiment of the drying method of the present disclosure, the drying method includes operations at blocks A10 to A30.

At block A10, drying progress parameters of a drying region are obtained at intervals of a first predetermined cycle.

In an embodiment, the drying method described above is applied in the drying device. The drying device has a corresponding drying region. The drying region is a space. The drying device is configured to perform the drying process on the drying region. The drying device is configured to enter a drying process in response to initiating a drying function of the drying device. The drying process may include one or more drying actions. Since different drying actions have different operation modes, different drying effects can be achieved. Also, different drying effects can be produced under different drying environments and different drying sequences. The drying action fails subsequent to an execution of the drying action for a period of time. That is, the drying action does not contribute the drying progress of the drying region. The drying action needs to be switched to improve the drying effect of the drying device.

Based on selections of the drying function, the drying process may include a plurality of drying actions having a predetermined operation sequence. For the drying process, the next drying action can also be determined in real time during operation of the drying process.

For one drying process, a target drying result required by the drying function needs to be achieved at an end of the drying process. For example, the target drying result is that a detected humidity change of the drying region reaches a threshold, humidity of the drying region is the same as humidity of an environment where the drying device is located, and the like. From a beginning of the drying process, with operation of each drying action, the target drying result is gradually approached. The drying process may be ended when the target drying result is reached.

The drying progress parameter indicates a progress status of the current drying process towards approaching the target drying result. The drying progress parameter may be a completion ratio value such as the dryness, or a specific number. For example, the target drying result requires the absolute humidity to drop to a predetermined value. The drying progress parameter may be a specific absolute humidity value.

Drying progress parameters of the drying region corresponding to different time points are determined and recorded at intervals of a first predetermined cycle. Therefore, a plurality of drying progress parameters may be obtained. The recorded drying progress parameter may be used to determine a progress status of the drying process at a time point corresponding to the recorded drying progress parameter.

At block A20, a drying trend of a current drying action is predicted based on the drying progress parameters to obtain a prediction result.

In an embodiment, one drying progress parameter may be used to determine a progress status at a time point corresponding to the one drying progress parameter, and a plurality of drying progress parameters may be used to determine drying progress change data between different time points, which can reflect a progress promotion effect of the drying action on the drying process in corresponding time periods. A progress promotion effect of the drying action on the drying process follows laws. The progress promotion effect of the drying action on the drying process in the future can be predicted based on the progress promotion effect already exerted by the drying action on the drying process. Therefore, all or part of the drying progress parameters corresponding to the current drying action may be obtained to predict the drying trend of the current drying action. The predicted drying trend may represent the progress promotion effect of the current drying action in the future.

In an embodiment, a start time point for recording the drying progress parameter may be before an initiation of the current drying action. The drying progress parameter corresponding to the current drying action may be obtained from the recorded drying progress parameters based on a time point for initiating the current drying action. The start time point for recording the drying progress parameter may be a time point at which the current drying action is initiated. The operation at block A10 is performed in response to initiating the current drying action. The drying progress parameters recorded in this way is the drying progress parameter corresponding to the current drying action. The start time point for recording the drying progress parameter may be after the initiation of the current drying action. The recorded drying progress parameters are all the drying progress parameters corresponding to the current drying action, which can at least reflect the progress promotion effect of the current drying action on the drying process in the past consecutive time periods including the current time period.

At block A30, an execution state of the current drying action is determined based on the prediction result.

In the present disclosure, the drying trend of the current drying action in a future predetermined time period may be predicted based on all or part of the drying progress parameters corresponding to the current drying action. A prediction result of the drying trend can reflect the progress promotion effect of the current drying action on the drying process in the future predetermined time period in a case where the current drying action is not continued to be executed. The execution state of the current drying action may be determined based on the progress promotion effect. In an embodiment, whether to continue executing the current drying action is determined based on the execution state. The next drying action is determined to be entered, in response to determining not to continue executing the current drying action. The next drying action is determined not to be entered, in response to determining to continue executing the current drying action.

In an embodiment, the next drying action may be determined based on a current operation environment of the drying device. The current operation environment may include the record of executed drying actions which are already executed, an ambient temperature, the maximum absolute humidity, etc. The next drying action is determined in real time based on the current operation environment. In an embodiment, when the drying process includes a plurality of drying actions having a predetermined execution sequence, the next drying action may also be determined based on the predetermined execution sequence.

In the technical solutions disclosed in the present disclosure, the drying progress parameters of the drying region of the drying device are obtained at intervals of the first predetermined cycle. The drying trend of the current drying action of the drying device in the future is predicted through the drying progress parameters. The execution state of the current drying action is determined based on the drying trend of the drying action in the future. In this way, the drying action can be switched in time prior to or in response to ineffectiveness of the drying effect of the current drying action, which always guarantees that the drying progress in the drying region is efficiently improved. Therefore, the drying efficiency of the drying device is improved, improving the drying efficiency.

In an embodiment, the drying trend of the current drying action is predicted, in response to a quantity of the obtained drying progress parameters reaching a predetermined value, based on the drying progress parameters.

In the present disclosure, a data volume of the drying progress parameters corresponding to the current drying action needs to be ensured, in such a manner that the drying trend of the current drying action can be predicted based on the drying progress parameters. Therefore, a cumulative quantity of the obtained drying progress parameters needs to be recorded. When the cumulative quantity of the obtained drying progress parameters reaches a predetermined value, the cumulative quantity may be construed as being capable of characterizing the progress promotion effect of the current drying action. The drying trend of the current drying action may be predicted based on recorded dryness parameters. In an embodiment, a quantity of drying progress parameters corresponding to the current drying action may be further determined. When the quantity reaches the predetermined value, the drying trend of the current drying action is predicted based on the recorded drying progress parameters corresponding to the current drying action.

In this way, by setting the predetermined value of the drying progress parameters and setting an adjustment of the drying trend, the drying trend of the current drying action can be ensured to be accurately predicted to improve a prediction accuracy and an accuracy in determining the execution state of the drying action. Therefore, the drying effect can be improved to improve the drying efficiency.

In an embodiment, the drying progress parameters include dryness. The operation of obtaining the drying progress parameters of the drying region at intervals of the first predetermined cycle includes: obtaining maximum humidity corresponding to the drying region; determining real-time humidity of the drying region at intervals of the first predetermined cycle; and determining the dryness based on the real-time humidity and the maximum humidity.

In the present disclosure, drying progress data includes dryness, which characterizes a completion status of moisture evaporation of the drying region.

The maximum humidity corresponding to the drying region is obtained prior to a determination of the drying progress parameters of the drying region. The humidity may be relative humidity or absolute humidity. The maximum humidity is the maximum humidity that can be achieved by the drying region after the drying action is performed on the drying region. In the drying process, the humidity detection device has a measurement limit, and the residual water keeps evaporating due to the water temperature and the drying action. Therefore, at a beginning of the drying action in the drying process or within a short period of time after the beginning of the drying process, the drying region is in the maximum limit state of humidity for a long time. With the operation of the drying action, the humidity of the drying region gradually decreases with the operation of the drying process. The dryness may be determined based on a ratio of the humidity that has been reduced to the remaining humidity or to the maximum humidity determined as to-be-reduced humidity. Therefore, a moisture evaporation state can be determined based on the dryness. In an exemplary embodiment of the present disclosure, vaporized moisture may be determined based on a difference between the maximum humidity and the real-time humidity. The dryness may be determined based on a ratio of the difference to the maximum humidity or the real-time humidity.

In this way, the parameter capable of characterizing the completion status of moisture evaporation of the drying region may be calculated based on initial maximum humidity and real-time humidity. The parameter plays a role of numerically expressing the effect of the current drying action in the entire drying process, improving the drying efficiency.

In an embodiment, the operation of determining the dryness based on the real-time humidity and the maximum humidity includes: obtaining ambient humidity of an environment where the drying device is located; and determining the dryness based on the real-time humidity, the ambient humidity corresponding to the drying device, and the maximum humidity.

Considering that there is still ambient humidity outside the drying device, the ambient humidity of the environment where the drying device is located may be determined as target humidity to be achieved by the drying process. The moisture evaporation state may be determined based on the target humidity and the real-time humidity, or an actual water amount to be removed may be calculated based on the ambient humidity and the maximum humidity. An actual water amount that has not been removed or has been removed may be determined based on the ambient humidity and the real-time humidity. The completion status of the moisture evaporation may also be determined. Based on a predetermined calculation method of the dryness, a detailed value of the dryness may be calculated to characterize the completion status of the moisture evaporation in the drying region. The present disclosure is not limited in this regard.

In this way, the parameter capable of characterizing the completion status of the moisture evaporation in the drying region can be calculated based on the initial maximum humidity, final target humidity determined based on the ambient humidity, and the real-time humidity. A role of the current drying action in the entire drying process can be more directly and accurately presented, further improving the drying efficiency.

In an embodiment, the drying progress parameters include real-time absolute humidity. The operation of determining and recording the drying progress parameters of the drying region at intervals of the first predetermined cycle includes: detecting a real-time temperature and real-time humidity of the drying region at intervals of the first predetermined cycle; and determining and recording the real-time absolute humidity of the drying region based on the real-time temperature and the real-time humidity.

In the present disclosure, the drying progress parameters may include the real-time absolute humidity capable of characterizing a moisture residue status of the drying region. In an exemplary embodiment of the present disclosure, the real-time temperature and the real-time humidity of the drying region are detected at intervals of the first predetermined cycle. The real-time absolute humidity is calculated based on the real-time temperature and the real-time humidity. The real-time absolute humidity is determined and recorded as the drying progress data. When the real-time absolute humidity is determined as the drying progress data, if the real-time absolute humidity decreases, the drying process approaches the target drying result; otherwise, the drying process is deviated from the target drying result.

In the present disclosure, to determine the real-time absolute humidity as the drying progress data, the real-time temperature and the real-time humidity only need to be collected at intervals of the first predetermined cycle and converted to express residual moisture in the drying region. Also, short time is spent on a determination, which can increase a speed of determining the drying progress parameters to improve an efficiency of predicting the drying trend, improving the drying efficiency.

In an embodiment, the operation at block A20 includes: determining a predictive drying progress parameter corresponding to a future predetermined time period based on the drying progress parameters; determining a rate of change of the predictive drying progress parameter corresponding to the future predetermined time period; and predicting the drying trend based on the rate of change corresponding to the future predetermined time period to obtain the prediction result.

In the present disclosure, the future predetermined time period may include several first predetermined cycles. In an embodiment, the future predetermined time period may include a predetermined quantity of consecutive first predetermined cycles subsequent to an end of the current first predetermined cycle. Drying progress change parameters between individual drying progress parameters may be determined based on a plurality of drying progress parameters corresponding to the current drying action. The predictive drying progress parameters corresponding to respective first predetermined cycles in the future predetermined time period are determined based on the drying progress change parameters. The predictive drying progress parameters corresponding to the respective first predetermined cycles are determined sequentially based on current drying progress parameters and a predictive drying progress change parameter.

In an embodiment, the rate of change corresponding to the predictive drying progress parameter of the future predetermined time period may be determined based on an absolute value of a difference between the predictive drying progress parameter closest to the target drying result corresponding to the future predetermined time period and the current drying progress parameter or the predictive drying progress parameter farthest from the target drying result corresponding to the future predetermined time period. In some embodiments, the rate of change corresponding to the predictive drying progress parameter of the future predetermined time period may be determined based on an absolute value of a difference between the current drying progress parameter or the predictive drying progress parameter corresponding to a start time point of the future predetermined time period and a predictive dryness parameter corresponding to an end time point of the future predetermined time period. The rate of change may be determined based on a ratio of the absolute value of the difference between the drying progress parameters at the start time point and the end time point to a time difference.

In this way, the predictive drying progress parameter corresponding to the future predetermined time period is determined through the drying progress parameters. The rate of change of the predictive drying progress parameter corresponding to the current drying action in the future predetermined time period is determined based on the predictive drying progress parameter. An overall drying progress promotion effect that the current drying action can also provide in the future predetermined time period is determined as a determination condition for the execution state of the drying action, which is more effective for the entire drying process and can improve the drying efficiency.

In an embodiment, the drying progress parameters include dryness. The operation of predicting the drying trend based on the rate of change corresponding to the future predetermined time period to obtain the prediction result includes: determining that the current drying action is effective in the future when the rate of change is greater than a predetermined value; and determining that the current drying action is to fail in the future when the rate of change is smaller than or equal to the predetermined value.

In the present disclosure, the drying progress parameters include the dryness or the real-time absolute humidity. The predictive drying progress parameter includes predictive dryness or predictive absolute humidity. The dryness is a parameter characterizing a completion degree of moisture evaporation of the drying device and tends to rise with the execution of the drying action. The real-time absolute humidity is a parameter characterizing a residual water volume of the drying device and tends to decrease with the execution of the drying action. The rate of change of the drying progress parameters is determined based on the ratio of the absolute value of the difference between the drying progress parameters at the start time point and the end time point to the time difference. That is, the rate of change increases as the real-time absolute parameter decreases at a higher rate or the dryness increases at a higher rate. The higher rate in the decrease of the real-time absolute parameter or in the increase of the dryness indicates that the current drying action has the progress promotion effect on the drying process in the future predetermined time period. When the rate of change is greater than the predetermined value, the drying trend is determined as that the current drying action is effective in the future. When the rate of change is smaller than or equal to the predetermined value, the drying trend is determined as that the current drying action is to fail in the future.

In this way, although different drying progress parameters exist, the rate of change of the drying progress parameters is used as a determination condition for determining whether the current drying action is effective in the future, which can improve an accuracy in predicting the drying trend, improving the drying efficiency.

In an embodiment, the operation at block A30 includes: determining, when the current drying action is effective in the future, the execution state as maintaining the current drying action; and determining, when the current drying action is to fail in the future, the execution state as executing a next drying action.

When the current drying action is determined to fail in the future, the current drying action exerts no progress promotion effect on the drying process in the future predetermined time period. The next drying action needs to be executed, or the next drying action is executed before the future predetermined time period. The next drying action may be determined based on a predetermined drying action sequence corresponding to the current drying process or may be determined in real time based on the current operation environment.

When the current drying action is determined as effective in the future, the current drying action continues to exert the progress promotion effect on the drying process in the future. The execution state may be determined as maintaining the current drying action. The next drying action is not executed, until next time the current drying action is determined as to fail.

In this way, the execution state may be determined, based on an effect of the current drying action in the future predetermined time period, as maintaining the current drying action or executing the next drying action. In this way, time for switching the drying action can be reduced using the drying effect of the current drying action. When the current drying action is to fail in the future, a switch to the next drying action is performed in time, improving the drying efficiency.

As illustrated in FIG. 6, according to any of the above embodiments, in another embodiment of the drying method of the present disclosure, the drying method further includes operations at blocks A100 to A300.

At block A100, pre-stored maximum humidity associated with the drying region is obtained in response to initiating the current drying action.

At block A200, the maximum humidity corresponding to the drying region is obtained in response to failing to obtain the pre-stored maximum humidity.

At block A300, the real-time humidity of the drying region is recorded, in response to successfully obtaining the pre-stored maximum humidity, at intervals of the first predetermined cycle based on the pre-stored maximum humidity.

In the present disclosure, the drying progress data includes the dryness. The dryness is determined based on the maximum humidity, the ambient humidity, and the absolute humidity corresponding to the first predetermined cycle. The maximum humidity that the current drying region can reach needs to be determined. The maximum humidity of the drying region varies from drying process to drying process. In addition, in response to initiating the drying process, the maximum humidity is reached in a short period of time. To accurately determine the maximum humidity, obtaining the maximum absolute humidity needs to begin at the beginning of the drying process.

The current drying action may be a beginning drying action of the drying process, prior to which the maximum humidity of the drying region in the current drying process is not determined. Also, the current drying action may not be the beginning drying action of the drying process, prior to which the maximum humidity of the drying region in the current drying process is determined. Therefore, in response to initiating the current drying action, the pre-stored maximum humidity associated with the drying region in the current drying process is obtained to determine whether the maximum humidity is determined. In response to failing to obtain the pre-stored maximum humidity, operations of obtaining the maximum humidity corresponding to the drying region and determining the real-time humidity of the drying region based on the maximum humidity at intervals of the first predetermined cycle to determine the dryness need to be started. In response to successfully obtaining the pre-stored maximum humidity, the operation of obtaining the maximum humidity corresponding to the drying region may be skipped, the pre-stored maximum humidity may be directly determined as the above-mentioned maximum humidity, and operations of recording the real-time humidity of the drying region at intervals of the first predetermined cycle and determining the dryness are performed.

In an embodiment, the maximum humidity obtained in response to initiating the current drying action may be stored in association with the current drying process. In this way, the pre-stored maximum humidity may be directly obtained in response to predicting other drying actions of the current drying process.

In an embodiment, subsequent to the initiation of the current drying action, the dryness is recorded and determined at intervals of the first predetermined cycle in response to a current humidity state exiting a maximum humidity state. In this way, changes caused by the current drying action can be reflected between the determined dryness. Therefore, all the obtained dryness can be used to predict the drying trend, which saves energy consumption.

In the technical solutions disclosed in the present disclosure, in response to initiating the current drying action, the pre-stored maximum humidity is obtained. The operation of obtaining the maximum humidity is initiated in response to failing to obtain the pre-stored maximum humidity. In this way, the maximum humidity for calculating the dryness can be quickly and accurately determined, improving the drying efficiency.

In an embodiment, the maximum humidity includes maximum absolute humidity. The operation of obtaining the maximum humidity corresponding to the drying region includes: detecting temperature data and humidity data of the drying region at intervals of a second predetermined cycle; determining absolute humidity of the drying region corresponding to the second predetermined cycle based on the temperature data and the humidity data; and determining the maximum absolute humidity based on the absolute humidity corresponding to a plurality of second predetermined cycles.

In the present disclosure, to more accurately represent a humidity state of the drying region, the absolute humidity may be obtained to represent the humidity of the drying region. The absolute humidity refers to a mass of water vapor contained in each cubic meter of humid air, i.e., a water vapor density. Correspondingly, the real-time humidity of the drying region determined at intervals of the second predetermined cycle may also be the real-time absolute humidity. In this way, when calculating the dryness, moisture conditions of the drying region and the environment may be directly expressed based on the maximum absolute humidity, the absolute ambient humidity, and the real-time absolute humidity. The dryness that needs to express the completion status of the moisture evaporation can be directly calculated, which can improve a calculation efficiency.

In response to determining the maximum absolute humidity, the absolute humidity at respective time points needs to be compared with each other to determine the maximum absolute humidity. Since the maximum absolute humidity is reached relatively fast, the temperature data and the humidity data of the drying region may be detected at intervals of the second predetermined cycle in response to initiating the drying process, or in response to starting the current drying action and no maximum absolute humidity being determined prior to the initiation of the current drying action. The absolute humidity corresponding to the second predetermined cycle is determined based on the temperature data or the humidity data. The maximum of the absolute humidity corresponding to the plurality of second predetermined cycles is determined as the maximum absolute humidity. Or an absolute humidity change function is fitted based on the absolute humidity corresponding to the plurality of second predetermined cycles. The maximum absolute humidity may be determined through the absolute humidity change function.

The second predetermined cycle may be shorter than or equal to the first predetermined cycle. A reason for the second predetermined cycle being shorter than the first predetermined cycle is that an emergence or a decline of the maximum absolute humidity of the drying region occurs quickly in response to a start of the drying process. Therefore, data needs to be collected in a relatively short cycle to determine the more accurate maximum absolute humidity. A reason for the second predetermined cycle being equal to the first predetermined cycle is that a need to collect the real-time humidity by means of the humidity detection device arises in response to both determining a drying process parameter at intervals of the first predetermined cycle and determining the absolute humidity at intervals of the second predetermined cycle. To save energy consumption and simplify an algorithm, the two operations can be performed simultaneously for data sharing.

In this way, with the maximum absolute humidity, a moisture density of the drying region can be better reflected. Therefore, the dryness obtained based on an absolute humidity calculation method can better characterize the completion status of the moisture evaporation. In this way, whether to switch the drying action is determined faster and more accurately, which can improve the drying efficiency.

In addition, the embodiments of the present disclosure further provide a drying device. The drying device includes a memory, a processor, and a drying program stored on the memory and executable on the processor. The drying program is configured to implement, when executed by the processor, the steps of the drying method according to any of the above embodiments.

In addition, the embodiments of the present disclosure further provide a computer-readable storage medium. The computer-readable storage medium stores a drying program. The drying program is configured to implement, when executed by a processor, the steps of the drying method according to any of the above embodiments.

It should be noted that, in the present disclosure, terms “comprise”, “include” or any other variations thereof are meant to cover non-exclusive including, such that the process, method, goods, or device including a series of elements do not only include those elements, but further include other elements that are not explicitly listed, or further include inherent elements of the process, method, goods, or device. In a case that there are no more restrictions, an element qualified by the statement “comprises a . . . ” does not exclude the presence of additional identical elements in the process, method, goods, or device that includes the said element.

The above sequence numbers of the embodiments of the present disclosure are for description only, and do not represent superiority or inferiority of the embodiments.

From the above description of the implementations, it will be clear to those skilled in the art that the method of the above embodiments can be implemented with the aid of software and a needed common hardware platform or can be implemented through hardware. In many cases, the former one is a better implementation. Based on this understanding, all or part of the technical solutions of the present disclosure, or the part thereof that contributes to the related art, can be embodied in the form of a software product. The computer software product is stored in the storage medium (such as a Read Only Memory (ROM)/Random Access Memory (RAM), a disk, and an optical disk) as described above and contains instructions to enable the drying device to perform the method described in each of the embodiments of the present disclosure.

Although some embodiments of the present disclosure are described above, the scope of the present disclosure is not limited to the embodiments. Any equivalent structure or equivalent process transformation made using the contents of the specification and the accompanying drawings of the present disclosure, or any direct or indirect application of the contents of the specification and the accompanying drawings of the present disclosure in other related fields, shall equally fall within the scope of the present disclosure.

1-21. (canceled)

22. A drying method comprising:
obtaining a drying parameter of a drying device;
determining a target drying action of the drying device based on a drying procedure matching the drying parameter; and
controlling the drying device to execute the target drying action.

23. The drying method according to claim 22, wherein determining the target drying action includes:
determining at least one candidate drying action based on the drying procedure;
determining dryness change data corresponding to the at least one candidate drying action in the drying procedure; and
determining the target drying action from the at least one candidate drying action based on the dryness change data.

24. The drying method according to claim 23, wherein determining the target drying action from the at least one candidate drying action includes:
obtaining current dryness of the drying device;
determining, based on the current dryness and the dryness change data, at least one drying duration and at least one dryness change value, each of the at least one drying duration and each of the at least one dryness change value corresponding to one of the at least one candidate drying action; and
determining the target drying action based on the at least one drying duration and the at least one dryness change value.

25. The drying method according to claim 24, wherein:
the dryness change data includes a plurality of time values and dryness corresponding to each of the plurality of time values; and
determining, based on the current dryness and the dryness change data, the at least one drying duration and the at least one dryness change value includes:
determining a time point corresponding to the current dryness based on the current dryness and the dryness change data; and
determining the at least one drying duration and the at least one dryness change value based on the time point, the current dryness, and the dryness change data.

26. The drying method according to claim 25, wherein determining the target drying action based on the at least one drying duration and the at least one dryness change value includes:
for each of the at least one candidate drying action:
obtaining a minimum cumulative duration required for a trend prediction of the candidate drying action; and
determining a drying rate corresponding to the candidate drying action based on the drying duration and the dryness change value corresponding to the candidate drying action; and
determining the target drying action to be one candidate drying action, of the at least one candidate drying action, having the drying duration longer than the minimum cumulative duration and having a greatest drying rate among the at least one candidate drying action.

27. The drying method according to claim 23, wherein determining the at least one candidate drying action based on the drying procedure includes:
determining an executed drying action, which is already executed by the drying device, based on the drying parameter;
determining a next drying action, in the drying procedure, corresponding to the executed drying action based on an execution sequence of the drying procedure; and
determining the next drying action as one of the at least one candidate drying action.

28. The drying method according to claim 22, wherein the drying parameter includes a record of one or more executed drying actions which have already been executed during a current drying process of the drying device and a humidity parameter corresponding to the drying device, the humidity parameter including at least one of ambient humidity of an environment where the drying device is located or maximum humidity corresponding to a drying region of the drying device.

29. The drying method according to claim 22, further comprising, prior to determining the target drying action:
pre-storing a plurality of drying procedures; or
collecting a plurality of pieces of execution data of the drying device, and generating and updating the drying procedure or updating a pre-stored drying procedure, based on the plurality of pieces of execution data of the drying device.

30. The drying method according to claim 22, further comprising, subsequent to controlling the drying device to execute the target drying action:
determining dryness of the drying device at intervals of a predetermined cycle in response to initiating the target drying action;
predicting a drying trend of the target drying action based on the dryness corresponding to a plurality of predetermined cycles, to obtain a prediction result; and
re-executing obtaining the drying parameter of the drying device, in response to determining based on the prediction result that the target drying action fails in a future time period.

31. A drying method comprising:
obtaining one or more drying progress parameters of a drying region at intervals of a predetermined cycle;
predicting a drying trend of a current drying action based on the one or more drying progress parameters to obtain a prediction result; and
determining an execution state of the current drying action based on the prediction result.

32. The drying method according to claim 31, wherein predicting the drying trend of the current drying action includes:
predicting, in response to a quantity of the one or more drying progress parameters that have been obtained reaching a predetermined value, the drying trend of the current drying action based on the one or more drying progress parameters.

33. The drying method according to claim 31, wherein:
the one or more drying progress parameters include dryness; and
obtaining the one or more drying progress parameters includes:
obtaining maximum humidity corresponding to the drying region;
determining real-time humidity of the drying region at intervals of the predetermined cycle; and
determining the dryness based on the real-time humidity and the maximum humidity.

34. The drying method according to claim 33, wherein determining the dryness based on the real-time humidity and the maximum humidity includes:
obtaining ambient humidity of an environment where the drying device is located; and
determining the dryness based on the real-time humidity, the ambient humidity, and the maximum humidity.

35. The drying method according to claim 33, further comprising:
obtaining, in response to initiating the current drying action, pre-stored maximum humidity associated with the drying region;
obtaining, in response to failing to obtain the pre-stored maximum humidity, the maximum humidity corresponding to the drying region; and
recording, in response to successfully obtaining the pre-stored maximum humidity, the real-time humidity of the drying region at intervals of the predetermined cycle based on the pre-stored maximum humidity.

36. The drying method according to claim 35, wherein:
the predetermined cycle is a first predetermined cycle;
the maximum humidity includes maximum absolute humidity; and
obtaining the maximum humidity corresponding to the drying region includes:
detecting temperature data and humidity data of the drying region at intervals of a second predetermined cycle;
determining absolute humidity of the drying region corresponding to the second predetermined cycle based on the temperature data and the humidity data; and
determining the maximum absolute humidity based on the absolute humidity corresponding to multiple ones of the second predetermined cycle.

37. The drying method according to claim 31, wherein:
the one or more drying progress parameters includes real-time absolute humidity; and
determining and recording the one or more drying progress parameters includes:
detecting a real-time temperature and real-time humidity of the drying region at intervals of first predetermined cycle; and
determining and recording the real-time absolute humidity of the drying region based on the real-time temperature and the real-time humidity.

38. The drying method according to claim 31, wherein predicting the drying trend of the current drying action includes:
determining a predictive drying progress parameter corresponding to a future predetermined time period based on the one or more drying progress parameters;
determining a rate of change of the predictive drying progress parameter corresponding to the future predetermined time period; and
predicting the drying trend based on the rate of change corresponding to the future predetermined time period to obtain the prediction result.

39. The drying method according to claim 38, wherein predicting the drying trend based on the rate of change corresponding to the future predetermined time period to obtain the prediction result includes:
determining that the current drying action is effective in future in response to the rate of change being greater than a predetermined value; and
determining that the current drying action is to fail in future in response to the rate of change being smaller than or equal to the predetermined value.

40. The drying method according to claim 38, wherein determining the execution state of the current drying action includes:
determining, in response to determining that the current drying action is effective in future, the execution state as maintaining the current drying action; and
determining, in response to determining that the current drying action is to fail in future, the execution state as executing a next drying action.

41. A drying device comprising:
a memory storing a drying program; and
a processor configured to execute the drying program to:
obtain a drying parameter of the drying device;
determine a target drying action of the drying device based on a drying procedure matching the drying parameter; and
control the drying device to execute the target drying action.
